(19) United States
(12) Patent Application Publication
(10) Pub. No.: US 2007/0257554 A1
(43) Pub. Date: Nov. 8, 2007

(54) Method for controlling releasing force for parking brake

(76) Inventors: Yeonho Kim, Suwon-city (KR); Kyung Won Hwang, Euijeongbu-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/603,870

(22) Filed: Nov. 22, 2006

(30) Foreign Application Priority Data
May 3, 2006 (KR) 10-2006-0040149

(51) Int. Cl. B60T 8/66

(52) U.S. Cl. 303/157

(57) ABSTRACT

A method for controlling releasing force for a parking brake applies a releasing force based on vehicle speed. Vehicle speed may be divided into several speed ranges between 0 and 5 km/h, each speed range having a releasing force. After applying the calculated releasing force, if the brake has not been released, the method may apply a maximum force. The method may further not engage the brake if the vehicle speed exceeds a predetermined speed.

### CROSS-REFERENCE TO RELATED APPLICATION

This application claims priority to and the benefit of Korean Patent Application No. 10-2006-0040149 filed in the Korean Intellectual Property Office on May 3, 2006, the entire contents of which are incorporated herein by reference.

### BACKGROUND OF THE INVENTION

(a) Field of the Invention

The present invention relates to a method for controlling releasing force for a parking brake of a hybrid vehicle.

More particularly, the present invention relates to a method for applying a releasing force for a parking brake wherein the force is selected based on a vehicle speed when the parking brake of a hybrid vehicle is engaged.

(b) Description of the Related Art

In a hybrid vehicle, the parking brake system is operated by a motor that engages a sprag to a parking gear. If vehicle speed is high when the sprag engages the parking gear, because an engaging force acting between the parking gear and the sprag is higher than the force applied by the motor, the parking gear is not released.

In addition, when the parking gear is released, because the parking gear is released regardless of the engaging force acting between the parking gear and the sprag, problems occur that an electric power of the vehicle is wasted.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a method for controlling a releasing force for a parking brake that releases a sprag operated by a motor of the parking brake of a vehicle, the method including detecting a vehicle speed when the parking brake is engaged, calculating an impulse between the parking gear and the sprag on the basis of the detected speed, and controlling the motor such that the motor generates a releasing force corresponding to the impulse.

The method may further include detecting if the sprag has been released from the parking gear, and controlling the motor to generate a maximum releasing force of the motor if the sprag has not been released.

The method may also include not operating the motor to engage the parking brake if the vehicle speed exceeds a predetermined speed when the driver operates the parking brake operating device, such a parking brake lever or a parking brake button. The predetermined speed may be approximately 5 km/h.

### BRIEF DESCRIPTION OF THE DRAWINGS

FIG. 1 shows an exemplary power delivery apparatus of a hybrid vehicle that utilizes the inventive method for controlling a releasing force for a parking brake;

FIG. 2 shows an exemplary parking brake system that utilizes the inventive method for controlling a releasing force for a parking brake;

FIG. 3 is a flowchart showing a method for controlling a releasing force for a parking brake according to an exemplary embodiment of the present invention; and

FIG. 4 is a chart showing an example of the correlation between speed, impulse, and releasing force utilized in the inventive method for controlling a releasing force for a parking brake.

### DETAILED DESCRIPTION OF THE PREFERRED EMBODIMENTS

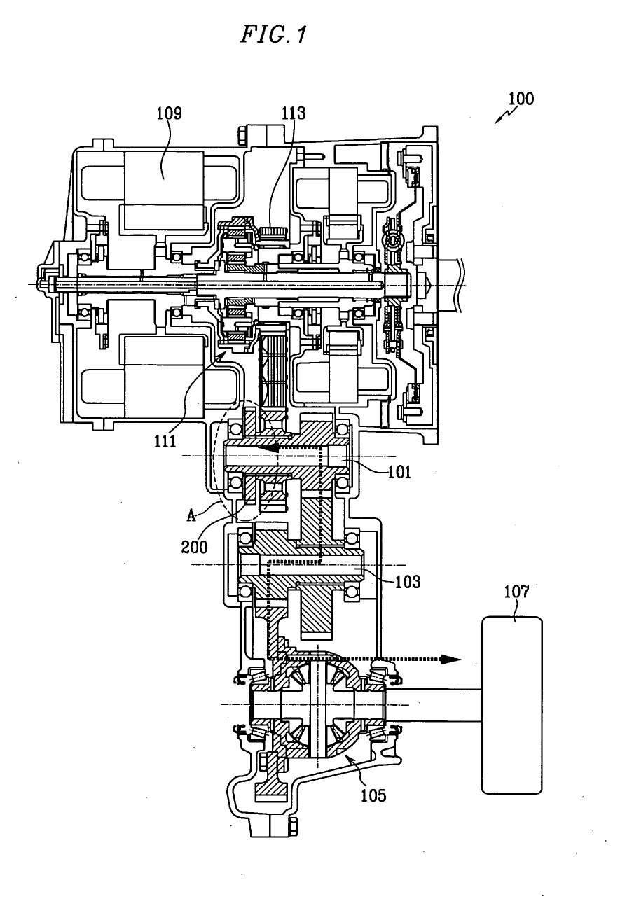

As shown in FIG. 1, according to an exemplary embodiment of the present invention, a power delivery apparatus 100 of a hybrid vehicle includes a motor 109 for a hybrid vehicle, a planetary gear set 111, a chain 113, a first shaft 101, a second shaft 103, and a differential gear 105. Power generated by the motor 109 or an engine is transmitted to the first shaft 101 through the planetary gear set 111 and the chain 113. Referring to the arrows shown in FIG. 1, the power transmitted to the first shaft 101 is transmitted to a wheel 107 through the second shaft 103 and the differential gear 105. Because the power delivery apparatus of the hybrid vehicle is well-known in the art, a further description is not deemed necessary.

A parking brake is mounted in portion A in FIG. 1.

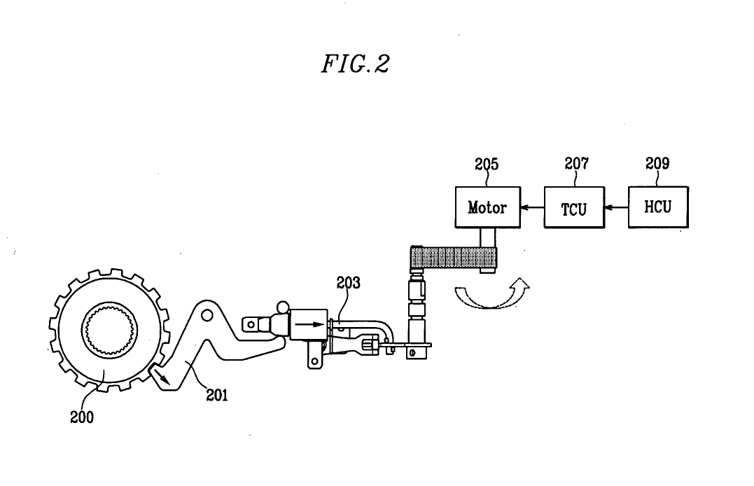

Referring also to FIG. 2, according to an exemplary embodiment of the present invention, the parking brake system includes a parking gear 200, a sprag 201, a wire 203, and a motor 205.

When a driver operates a parking brake operating device, such as a parking brake lever or parking brake button, the wire 203 is pulled by the motor 205. The sprag 201 then rotates in a clockwise direction in FIG. 2 and engages with the gear teeth of the parking gear 200.

When the driver releases the parking brake operating device, the motor 205 operates in the opposite direction and the sprag 201 rotates counterclockwise in FIG. 2, releasing the parking brake.

The parking brake system may be controlled by a transmission control unit (TCU) 207. TCU 207 may comprise a processor, memory, and associated hardware, software, and/or firmware as may be selected and programmed by a person of ordinary skill in the art based on the teachings of the present invention. In an exemplary embodiment, the TCU 207 comprises at least one microprocessor operated by a predetermined program that includes instructions to perform the inventive method, which will be described in more detail below.

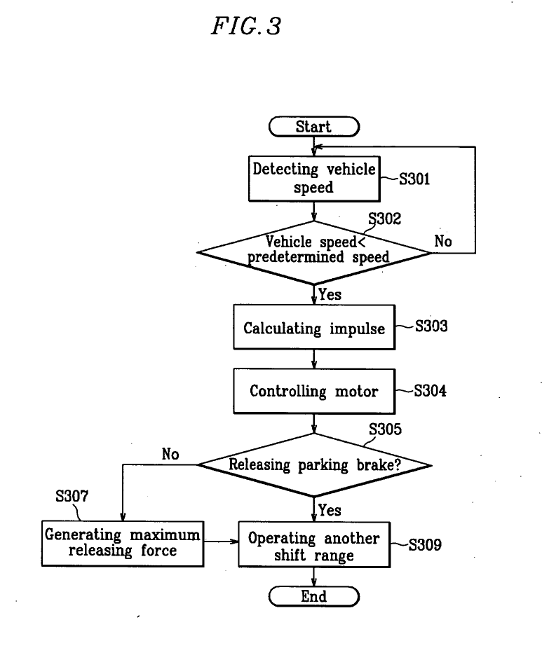

Referring to FIG. 3, an exemplary method for controlling the releasing force for a parking brake, which releases the sprag of the parking brake of the vehicle from the parking gear, first detects a vehicle speed when the parking brake is engaged at step S301. The vehicle speed may be detected by a hybrid control unit (HCU) 209. HCU 209 may comprise a processor, memory, and associated hardware, software, and/or firmware as may be selected and programmed by a person of ordinary skill in the art based on the teachings of the present invention.

After the speed is detected, the transmission control unit 207 determines if the detected speed is more than a predetermined speed at step S302. If the detected speed is less than the predetermined speed, the transmission control unit 207 calculates an impulse acting, between the parking gear 200 and the sprag 201 on the basis of the detected speed at step S303.

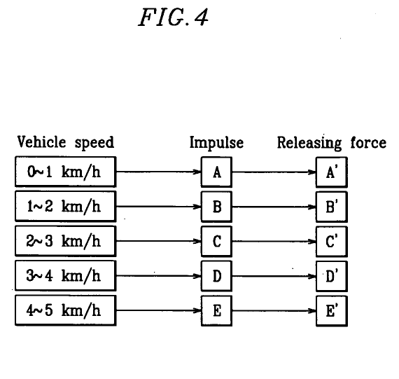

Referring to FIG. 4, according to an exemplary embodiment of the present invention, the detected speed may be divided into five speed ranges. The impulse corresponding to each speed range depends on weight and capacity of the motor 205 of the vehicle, and may be determined experimentally for each vehicle type and stored in the transmission control unit 207. For example, if the vehicle speed is 0 to 1 km/h when the parking brake is engaged, the transmission control unit 207 may calculate that the impulse is A.

The releasing force corresponding to the calculated impulse is then determined. The relationship between the impulse and the releasing force depends on weight and capacity of the motor 205 of the vehicle, and may be determined experimentally for each vehicle type and stored in the transmission control unit 207. For example, if the vehicle speed is 0 to 1 km/h when the parking brake is engaged, the transmission control unit 207 may calculate that the impulse is A, and the releasing force is A′.

When the parking brake is released, the transmission control unit 207 controls the motor 205 such that the motor 205 generates the releasing force A′ that corresponds to the calculated impulse A corresponding to the vehicle speed when the parking brake was engaged at step S304. Therefore, an optimal releasing force can be generated because the releasing force that corresponds to the impulse corresponding to the speed when the parking brake of the vehicle is engaged can be calculated.

In addition, power efficiency of the vehicle is improved when the parking brake is released.

The transmission control unit 207 may then detect if the sprag 201 has been released from the parking gear 200 at step S305. If the sprag 201 has been released from the parking gear 200, the transmission control unit 207 controls such that the power delivery apparatus of the hybrid vehicle changes gears at step 309. If the sprag 201 has not been not released, the transmission control unit 207 controls the motor 205 such that the motor 205 generates a maximum releasing force at step S307.

Thus, if the vehicle is parked on a hill, an actual impulse between the parking gear 200 and the sprag 201 may be larger than the calculated impulse. In this case, because the parking brake may not be released although the releasing force corresponding to the detected vehicle speed is generated, the transmission control unit 207 controls the motor 205 to generate the maximum releasing force such that the parking brake is released. The maximum releasing force varies with capacity of the motor 205.

If the vehicle speed exceeds a predetermined speed when the parking brake of the vehicle is engaged, the transmission control unit 207 does not operate the motor 205 at step S302. Because a releasing force that exceeds the capacity of the motor 205 may be necessary if the vehicle speed exceeds the predetermined speed, the transmission control unit 207 does not operate the motor 205 in this case. That is, if the vehicle speed exceeds the predetermined speed, the sprag 201 is not engaged to the parking gear 200.

As shown in FIG. 4, the predetermined speed may be 5 km/h, but it may vary with the weight and the motor capacity of the vehicle.

According to the present invention, when the parking brake is released, because a releasing force corresponding to a vehicle speed range is applied, power of the vehicle is not wasted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling a releasing of a parking brake, said brake releasing comprising releasing a sprag from a parking gear by operating a motor, the method comprising:
detecting a vehicle speed when the parking brake is engaged;
calculating an impulse between the parking gear and the sprag based on the vehicle speed; and
controlling the motor such that the motor generates a releasing force corresponding to the impulse.

2. The method of claim 1, further comprising:
detecting if the sprag is released from the parking gear; and
controlling the motor to generate a maximum releasing force if the sprag is not released.

3. The method of claim 1, further comprising engaging the parking brake only if the vehicle speed is less than a predetermined speed.

4. The method of claim 3, wherein the predetermined speed is approximately 5 km/h.

5. A method for controlling a releasing of a parking brake, said brake releasing comprising releasing a sprag from a parking gear by operating a motor, the method comprising:
detecting a vehicle speed when the parking brake is engaged; and
controlling the motor to produce a releasing force based on the vehicle speed.

6. The method of claim 5, further comprising:
detecting if the sprag is released from the parking gear; and
controlling the motor to generate a maximum releasing force if the sprag is not released.
